(19) United States
(12) Patent Application Publication
(10) Pub. No.: US 2009/0262921 A1
(43) Pub. Date: Oct. 22, 2009

(54) Unified Services Taxonomy For Converging Network Solution Platforms

(76) Inventors: Arun Rao Poghul, Bangalore (IN); Gerald William Winsor, Cupertino, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/238,458

(22) Filed: Sep. 26, 2008

(30) Foreign Application Priority Data
Apr. 22, 2008 (IN) 994/CHE/2008

(51) Int. Cl. H04M 7/00

(52) U.S. Cl. 379/229

(57) ABSTRACT

Systems and methods for categorizing and mapping telecommunication services are provided. In this regard, a representative system in a communication, media, and entertainment (CME) environment, among others, includes at least one service provider that is a part of the CME environment. The service provider includes a computing device having a processing device that facilitates execution of programs stored in the computing device, and memory that is electrically coupled to the processing device. The memory is configured to store the programs that include a taxonomy manager, the taxonomy manager being configured to identify entities of a communication, media and entertainment environment (CME). The CME environment includes at least one service provider having multiple telecommunication platforms. The entities are associated with the multiple telecommunication platforms. The taxonomy manager is further configured to identify entities in a shared information and data model (SID), map the CME environment entities to the SID entities, and develop a taxonomy for the CME environment.

### TECHNICAL FIELD

The present disclosure generally relates to network solution infrastructures, and more particularly, the disclosure relates to systems and methods for categorizing and mapping telecommunication services.

### BACKGROUND

Telecommunication operators' environments typically utilize several platforms to implement their operational infrastructure. Each platform is typically a stand-alone entity satisfying business requirements within the environment. Each provider uses the platforms and has its own semantics and classification mechanisms for defining “services” and “products.” For example, a provider utilizes service delivery platforms (SDP), broadband and media platforms, and operational support systems (OSS) platforms, among other platforms. Integrating these non-unified platforms results in a disjointed deployment model whereby SDP and OSS platforms, for example, reference the same capability, element, or function, as different service descriptions in their own respective systems, resulting in generally complex logic to map SDP elements to OSS elements.

### SUMMARY

Systems and methods for categorizing and mapping telecommunication services are provided. In this regard, a representative system in a communication, media, and entertainment (CME) environment, among others, includes at least one service provider that is a part of the CME environment. The service provider utilizes a computing device having a processing device that facilitates execution of programs stored in the computing device, and memory that is electrically coupled to the processing device.

The memory is configured to store the programs that include a taxonomy manager, the taxonomy manager being configured to identify entities of a communication, media and entertainment environment (CME). The CME environment includes at least one service provider having multiple telecommunication platforms. The entities are associated with the multiple telecommunication platforms. The taxonomy manager is further configured to identify entities in a shared information and data model (SID), map the CME environment entities to the SID entities, and develop a taxonomy for the CME environment.

A method that categorizes and maps telecommunication services comprises identifying entities of a communication, media and entertainment (CME) environment; identifying entities in a shared information and data model (SID); mapping the CME environment entities to the SID entities; and developing a taxonomy for the CME environment.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a service environment that converges service platforms associated with respective service providers.

FIG. 2 is a block diagram of a communications, media, and entertainment environment, such as that shown in FIG. 1.

FIG. 3 is a block diagram that illustrates exemplary architecture, functionality, and/or operation of various service providers and a central repository, such as that shown in FIG. 1.

FIG. 4 is a block diagram that illustrates exemplary architecture, functionality, and/or operation of a taxonomy manager, such as that in FIG. 3.

FIG. 5 is a flow chart that illustrates exemplary architecture, functionality, and/or operation of a standardized definition module, such as that shown in FIG. 4.

FIG. 6 is an exemplary taxonomy tree that illustrates exemplary architecture, functionality, and/or operation of a categorization module, such as that shown in FIG. 4.

FIG. 7 is a flow chart that illustrates exemplary architecture, functionality, and/or operation of an optimization module, such as that shown in FIG. 4.

FIG. 8 is a flow chart that illustrates exemplary architecture, functionality, and/or operation of a link module, such as that shown in FIG. 4.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which services can be classified or categorized into a hierarchical structure for association, evaluation, and searching of services. The systems and methods can be used in a unified and consistent manner by service delivery platforms (SDP), broadband and media platforms, and operation support systems (OSS) platforms, among other various converging network solution platforms, which can exist within a telecommunication or media and entertainment operator's environment.

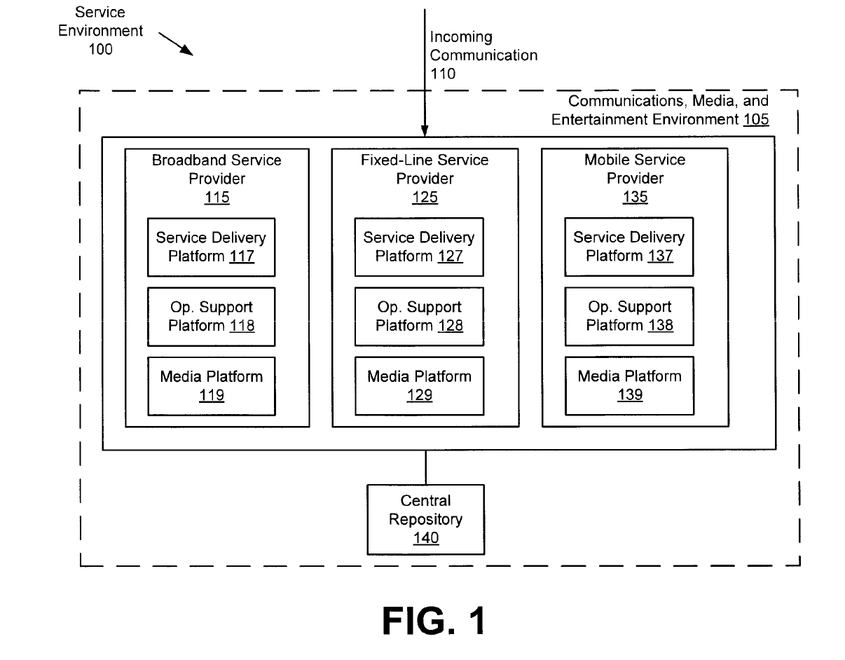

FIG. 1 is a block diagram of a service environment 100 that converges service platforms associated with respective service providers. A representative service environment 100, such as that shown in FIG. 1, includes a telecommunication environment 105 that receives incoming calls 110. The telecommunication environment 105 includes, but is not limited to, at least one of the following provider: broadband service provider 115, fixed-line service provider 125, and mobile service provider 135. Each provider 115, 125, 135 can utilize a service delivery platform 117, 127, 137, operational support platform 118, 128, 138 and media platform 119, 129, 139, among other platforms. In general, a provider generally utilizes a computing system that is incapable of accurately exchanging reciprocal operations and data structures with another computing system without having to implement some transformation mechanism for data exchange. For example, the broadband service provider 115 generally cannot exchange information with the mobile service provider 135.

Generally, the broadband service provider 115, mobile service provider 135, and fixed-line service provider 125 provide services and products associated with broadband, mobile and fixed-line telecommunications. The service delivery platform 117, 127, 137 includes an integrated suite of software products and solutions that enable network operators to develop, deploy, deliver, and manage media and data related services quickly and cost-effectively.

The operational support platform 118, 128, 138 includes network systems associated with the telecommunication environments that support processes, such as, maintaining network inventory, provisioning products and customers, configuring network components, and managing faults, among other processes. The media platform 119, 129, 139 generally refers to the ingestion, management and distribution of media products and content.

The providers can utilize mechanisms that have been standardized by, for example, a TeleManagement Forum (TMF), which is an international consortium of communication service providers and their suppliers. Its mission is to help service providers and network operators automate their business in a cost and time effective way; however, TMF mechanisms are not applied in a consistent manner.

Shared Information and Data (SID) model is a part of TMF's new generation operations systems and software (NGOSS) initiative. NGOSS includes a set of principles and technical deliverables. SID includes data standards that are rules that are used to describe how elements, data and functions can be created and used in information systems. Using data standards, employees from different providers and located in different geographical locations can use the same information system definitions (data model) to describe the mappings to real world entities such as products, services and resources. SID can provide a common vocabulary and set of information/data definitions and relationships used in the definition of NGOSS architectures.

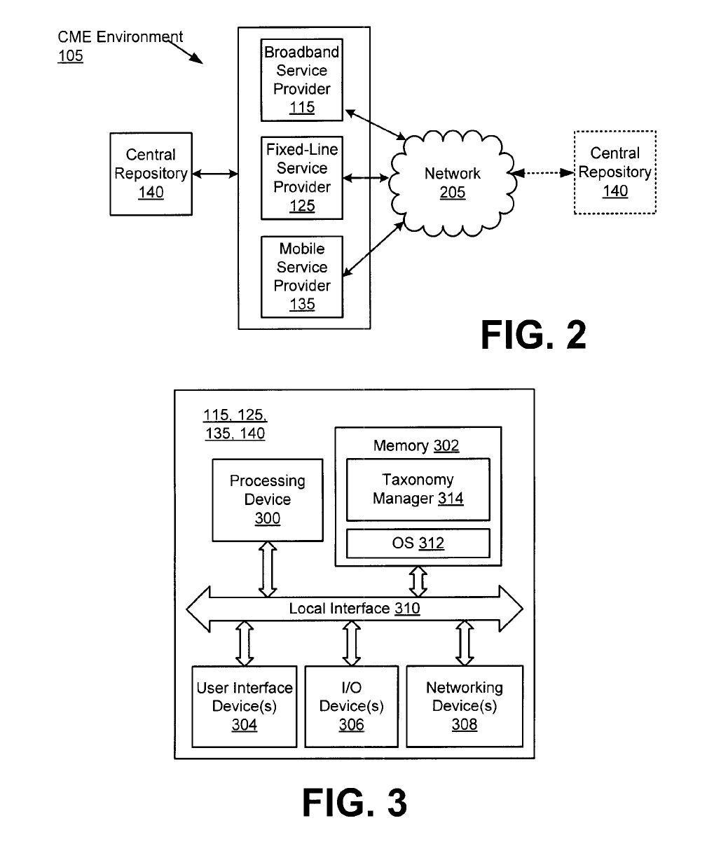

FIG. 2 is a block diagram of a communications, media, and entertainment (CME) environment 105, such as that shown in FIG. 1. The CME environment 105 includes, for example, the systems of FIG. 1, namely, the broadband service provider 115, the fixed-line service provider 125, the mobile service provider 135, and the central repository 140. The providers and central repository each represent a plurality of servers/clients that may exist in the CME environment 105. Each of the systems of FIG. 2 is coupled to an appropriate network 205. The network 205 includes, for example, the Internet, intranets, wide area networks (WANs), local area networks, wireless networks, or other suitable networks, etc., or any combination of two or more such networks. The providers 115, 125, 135 and central repository 140 are further described in relation to FIG. 3.

FIG. 3 is a block diagram that illustrates exemplary architectures for the broadband service provider 115, the fixed-line service provider 125, the mobile service provider 135, and the central repository 140, such as that shown in FIG. 1. As indicated in FIG. 3, the providers 115, 125, 135 and/or the central repository 140 each can include a processing device 300, memory 302, one or more user interface devices 304, one or more I/O devices 306, and one or more networking devices 308, each of which is connected to a local interface 310. The processing device 300 can include any custom made or commercially available processor, a central processing unit (CPU) or an auxiliary processor among several processors associated with the providers 115, 125, 135 and/or the central repository 140, a semiconductor based microprocessor (in the form of a microchip), or a macroprocessor. The memory 302 can include any one or a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 304 comprise those components with which the user (e.g., administrator) can interact with the providers 115, 125, 135 and/or the central repository 140. Where the providers 115, 125, 135 and/or the central repository 140 include a server computer or similar device, these components can comprise those typically used in conjunction with a PC such as a keyboard and mouse.

The one or more I/O devices 306 comprise components used to facilitate connection of the providers 115, 125, 135 and/or the central repository 140 to other devices and therefore, for instance, comprise one or more serial, parallel, small system interface (SCSI), universal serial bus (USB), or IEEE 1394 (e.g., Firewire™) connection elements. The networking devices 308 comprise the various components used to transmit and/or receive data over the network 205, where provided. By way of example, the networking devices 308 include a device that can communicate both inputs and outputs, for instance, a modulator/demodulator (e.g., modem), a radio frequency (RF) or infrared (IR) transceiver, a telephonic interface, a bridge, a router, as well as a network card, etc.

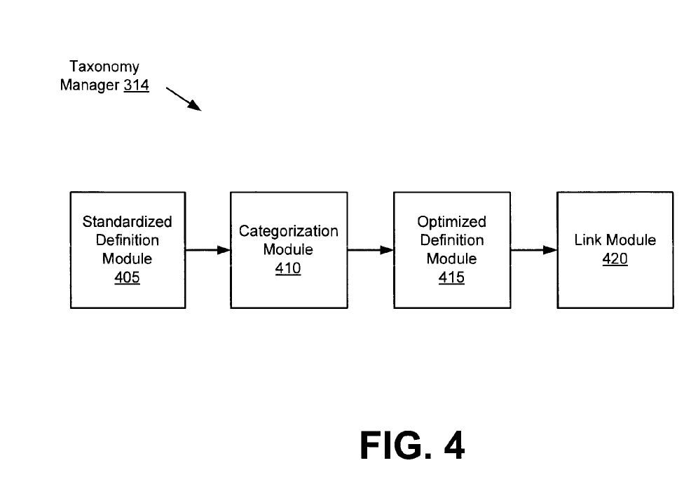

The memory 302 normally comprises various programs (in software and/or firmware) including an operating system (O/S) 212 and a taxonomy manager 314. The O/S 312 controls the execution of programs, including the taxonomy manager 314, and provides scheduling, input-output control, file and data management, memory management, and communication control and related services. The taxonomy manager 314 facilitates classifying or categorizing description of services into a hierarchical structure for association, evaluation, and searching of services, all maintained within the central repository. Operations of the taxonomy manager 314 are described in relation to FIGS. 4-8.

FIG. 4 is a block diagram that illustrates exemplary architecture, functionality, and/or operation of a taxonomy manager 314, such as that in FIG. 3. The taxonomy manager 314 attempts to define the key domains of a telecommunication operator versus services, products and resources and distinguish between them since the terms service and product tend to be used interchangeably while relationships between resources and services are often not clear. Some of the terminologies that the taxonomy manager 314 implements include, but are not limited to, business entity, attribute, relationship, aggregate business entity (ABE) and domain, among other terminologies.

Business entity generally refers to something of interest to the appropriate business entity (within its domain) that may be tangible, active or conceptual things. They are characterized by attributes and participate in relationships with other business entities and move through a well-defined life-cycle management process. Business entities in the product domain typically represent what are offered to the market while those in the services and resource domains chiefly represent how they are implemented.

An attribute is a fact that describes a Business entity. A relationship is an association of business interest between two Business entities or between a Business entity and itself. An aggregate business entity (ABE) is a well-defined set of information and operations that characterize a highly cohesive, loosely coupled set of Business entities. A domain is a collection of ABEs associated with a specific management area.

For example, a customer buys a product which may be made up of one or more services realized by one or more resources. Service is related to other business entities such as operations, billing, customer, enterprise etc. The taxonomy manager 314 can organize these ABEs into various levels as a structured inverted hierarchy, each subsequent level defining a further level of detail. The taxonomy manager 314 can expand into the service entity domain, delving into the sub-levels of its definition while maintaining the appropriate level of detail of the other entities in context.

The taxonomy manager 314 includes a standardized definition module 405 that standardizes the entities and characteristics of the services in the various converging network solution platforms and sends the standardized data to a categorization module 410. The categorization module 410 categorizes the standardized data and sends the categorized data to an optimization module 415. The categorization module 410 provides a taxonomy tree associated with the optimized data, resulting in a consistent classification (semantics) and categorization (structure) for telecommunications services that can be applied across telecommunications platforms through a central repository, based on the TMF SID.

The optimized definition module 415 optimizes the categorized data and sends the optimized data to a link module 420. The taxonomy manager 314 can provide standards based on the classifying and composing of service definition and prevent service data fragmentation. The taxonomy manager 314 can provide inter-platform-operability and prevent multi-point integrations for services. The taxonomy manager 314 can prevent unnecessary data exchange on services and enable a single logical and physical view of services.

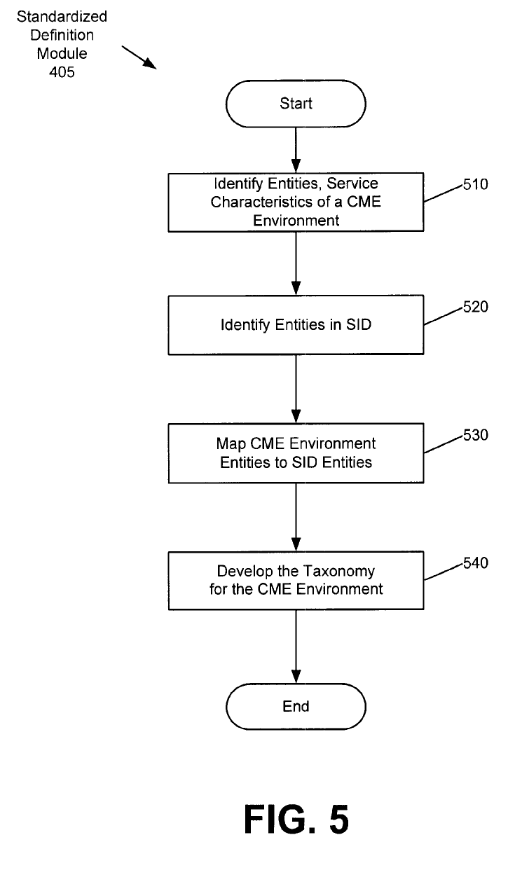

FIG. 5 is a flow chart that illustrates exemplary architecture, functionality, and/or operation of a standardized definition module, such as that shown in FIG. 4. Beginning with block 510, the standardized definition module 405 identifies entities and characteristic of the various converging network solution platforms in the CME environment 105. For example, the service entities can include, but not limited to, product, service, enabler (a tangible entity representing some physical network resource), mobile network operator, service provider, content provider, third party service provider, subscriber, and service consumer (user). The service characteristics can include, but not limited to, versioning, bandwidth requirements, customer identity, device characteristics and capabilities, and quality of service (QoS).

In block 520, the standardized definition module 405 uses SID to provide a common language among the providers 115, 125, 135 and identifies the various entities in the providers 115, 125, 135. The SID entities can be classified into two levels. The first level includes product, service, resource and party. The second level includes product offering, product specification, service specification, customer facing service (CFS), resource facing service (RFS), service characteristic, RFS atomic, RFS composite, logical resource (LR), physical resource (PR), and party role.

In block 530, the CME environment entities are mapped to the SID entities. Below are exemplary mapping tables. Based on the mapped entities, the standardized definition module 405 can develop a taxonomy for the CME environment 105, as shown in block 540.

TABLE A

| CME Entities | SID Entities |
|---|---|
| Product | Product & ProductOffering |
| Service | Service, ServiceSpecification, CFS, |
| | RFS |
| Enabler | Resource, LR, PR |
| MNO | PartyRole |
| Service Provider | PartyRole |
| Content Provider | PartyRole |
| Third Party Provider | PartyRole |
| Subscriber | PartyRole |
| User | PartyRole |

TABLE B

| CME Characteristics | SID Entities |
|---|---|
| Versioning | ServiceSpecVersion |
| Bandwidth | ServiceCharacteristic |
| QoS | ServiceCharacteristic |

Services are generally inherently manageable entities that can be used to implement a product and can be bound to them. A product defines the context of the service. Service related entities are related to entities in the resource, product and other domains through a set of relationships.

Each service instance can be different; therefore, each service can include at least one of the following: changeable attributes, methods, relationships and constraints. The invariant service can be defined by a ServiceSpecification. Service can provide a convenient point to define how services interact with other business entities. Since applications can distinguish between different versions of objects, the ServiceSpecVersion class is used to represent a form or variety of a ServiceSpecification that is different from others or from the original. The differences should be such that it is not sufficient to warrant creating a new ServiceSpecification itself.

Business entities in the product domain represent what are offered to the market while those in the Services and resource domains chiefly represent how they are implemented. A service provider maintains agreements with a mobile network operator for use of the network to provide services. The mobile network operator (MNO) owns and maintains the physical mobile network in a given geography. In some cases, the mobile network operator and service provider may be the same company. Information derived from the actual network may be requested from the mobile network operator to help fulfill a User request.

A third party service provider is generally a company who wishes to provide a service, but does not wish to have their own agreements with the mobile network operators. A third party service provider can leverage the agreements already in place between the mobile network operator and the service provider by selling the service via a service provider.

A content provider is generally a company who provides content, but like the third party service provider, does not wish to have their own agreements with the mobile network operators. A content provider can provide its service to content aggregators, third party service providers and service providers.

An enabler is generally a technology intended for use in the development, deployment or operation of a service. A subscriber is generally an entity which maintains a contract with one or more service providers on the behalf of one or more users. A subscriber may be a corporation subscribing to mobile services for its employees. The user generally buys the ProductOffering and consumes the services. The user may also be the subscriber, as is the case for a consumer service contract.

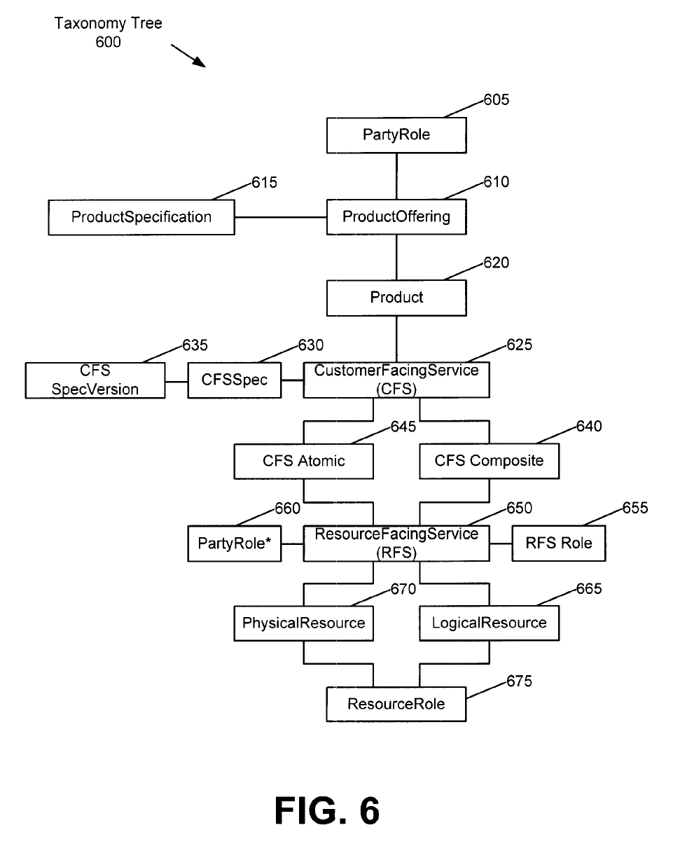

FIG. 6 is an exemplary taxonomy tree 600 that illustrates exemplary architecture, functionality, and/or operation of the categorization module 410, such as that shown in FIG. 4. The CME entities used in the taxonomy tree 600 map directly to the SID entities definitions. As shown in FIG. 6, the taxonomy tree 600 includes a party role entity 605. The party role entity 605 generally refers to organizations such as mobile network operators (MNOs) that market, sell or lease product offerings to end-users/customers. Product offerings 610 could be either tangible or intangible entities and may be either bundled or simple in nature.

Party role 605 could also be used to denote end-users/customers. In the SID, party role 605 is not directly related to product offering. Here, SID's definition of a party role 605 has been used to make product offerings 610 to end-users/customers. Product specification 615 is used to hold a set of invariant data, e.g., the common attributes, and across product offerings. For example, an e-mail specification may be used across a number of product offerings. Thus, a product offering 610 is a packaging of zero or more product specifications realized by zero or more products.

A product 620 is generally a collection of, for example, zero or more customer facing services (CFS) 625, such as an email service, web hosting service, content download service, video streaming service, etc. The cardinality is generally, for example, zero or more on the CFS side 625, in order to enable a communications, media or entertainment operator to develop a service before they are a part of a product 620. The cardinality is generally, for example, one or more on the product side 620 to denote that once a service is implemented or deployed, it can be offered only through a product 620.

A CFS 625 is visible and purchasable by end-users/customers. In SID, CFS 625 is derived out of an abstract service class. A product 620 may be either stand-alone or bundled from other products. This relationship is generally defined in the SID, but not explicitly shown in the tree.

As in product offering 610, CFS specification 630 contains the invariant data (common portions) across CFS 625. This allows a product 620 to, in effect, customize a CFS 625. The CFS specification version 635 can be used to handle the versioning of a CFS 625—a common feature of service life-cycle. (Note: If the differences between versions are large, a different CFS Spec could be used). To model the characteristics of a service, such as, bandwidth, device capabilities, QoS etc., service characteristic entity (not shown) could be used and related to CFS 625. As a modification, the variant and invariant parts service characteristic could be combined with CFS 625 or CFS Specification 630, respectively.

CFS 625 can include the role in which it is utilized into a product 620. The CFS Role can be used to position the same CFS in products in different roles. A CFS 625 might be a single service or could be comprised of a bundle of services. The CFS Composite 640 and CFS Atomic 645 entities capture these relationships.

The CFS composite 640 and/or atomic 645 are realized through ResourceFacingServices (RFS) 650. The RFS 650 can be configured such that the RFS 650 does not interact with the end-user/customer. The RFS 650 can be configured to support the CFS 625 and is related to the underlying network resources. The RFS 650 in SID can be derived out of the service entity. RFS role 655 can be configured to enable the same RFS 650 playing different roles. The party role entity 660 associated with RFS 650 could be used to denote the service/content providers providing/hosting the RFS 650.

In general, resources are utilized by RFS 650 to realize a service. The LogicalResource 665 (such as Memory and Device interfaces) and PhysicalResource 670 (such as a physical device, ports etc) can be used for this purpose. In SID, The LogicalResource 665 and PhysicalResource 670 are derived out of a resource entity. The ResourceRole entity 675 is used to provide a way for either a logical or physical resource to play different roles in different services. For example, a PhysicalResource 670 such as a router can play the role of a customer premises equipment or a provider edge router. Similarly, a LogicalResource 665 could play a routing role or a firewall role.

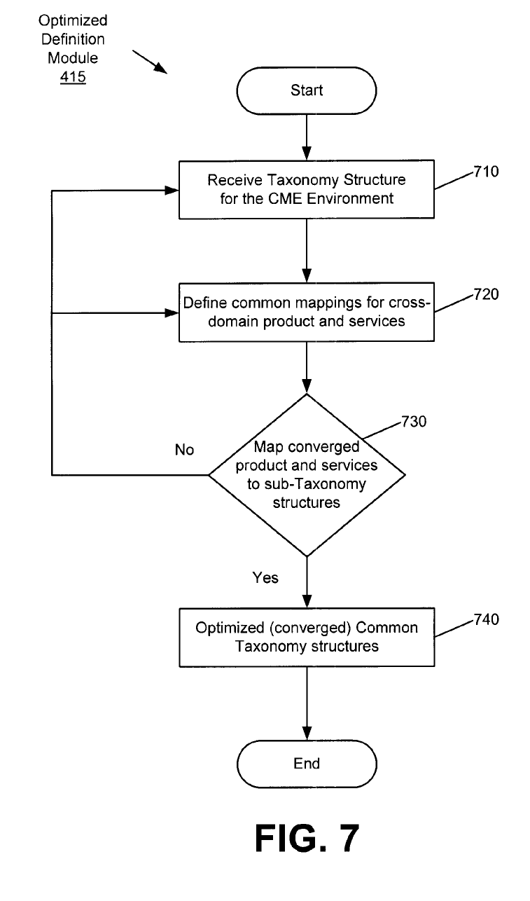

FIG. 7 is a flow chart that illustrates exemplary architecture, functionality, and/or operation of an optimized definition module 415, such as that shown in FIG. 4. As mentioned above, the optimized definition module 415 optimizes the categorized data and sends the optimized data to a link module 420. In step 710, the optimized definition module 415 receives the taxonomy structure for the CME environment from the categorization module 410. In step 720, the optimized definition module 415 defines common mappings for cross-domain product and services. For example, a content delivery service (an SDP delivered service) can be mapped to media platform service that defines pre- and/or post-processing functions, or device characteristic requirements.

In step 730, the optimized definition module 415 maps the converged product to sub-taxonomy structures. If the converged product cannot be mapped to the sub-taxonomy structures, the optimized definition module 415 continues back to either step 710 or step 720, or both. If the converged product can be mapped to the sub-taxonomy structures, then in step 740 the optimized definition module 415 converges the common taxonomy structures that are implemented at multiple service providers in the CME environment. For example, a content delivery service is fully resolved, and described by, SDP and Media Platform taxonomy structures.

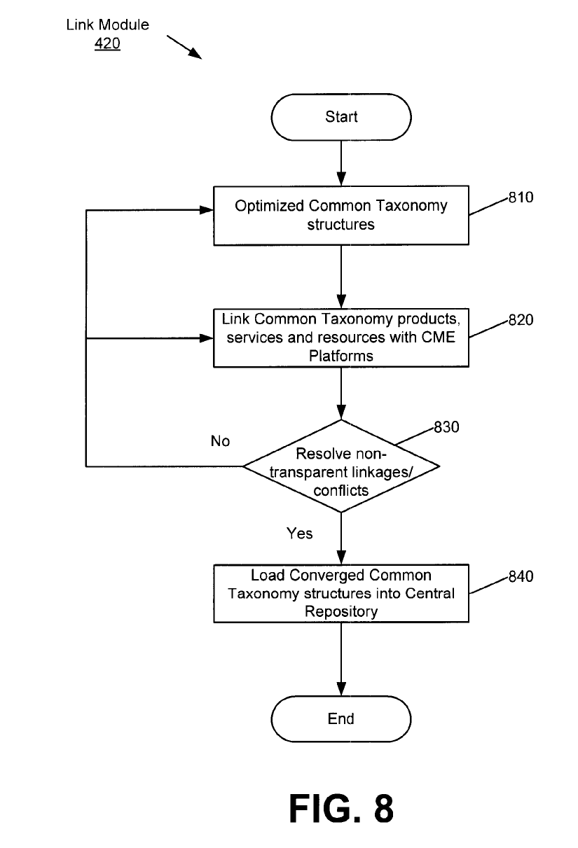

FIG. 8 is a flow chart that illustrates exemplary architecture, functionality, and/or operation of a link module 420, such as that shown in FIG. 4. In steps 810 and 820, the link module 420 optimizes common taxonomy structures and links common taxonomy products, services and resources with CME platforms. For example, a content delivery service defined through SDP and Media Platform taxonomies, within the common taxonomy, is linked to the actual SDP defined service delivery functions, which may also be linked to OSS service taxonomy pre-processing requirements such as ensuring sufficient network resources are reserved to ensure successful delivery of the content.

In step 830, the link module 420 resolves non-transparent linkages and conflicts. If the non-transparent linkages and conflicts cannot be resolved, the link module 420 continues back to either step 810 or step 820, or both. If the non-transparent linkages and conflicts can be resolved, then in step 840 the link module 420 loads the converged common taxonomy structures into central repository. For example, having resolved and defined pre- and/or post-processing requirements through the different sub-taxonomy structures the content delivery service is now ‘fully resolved’ and can be expressed and exposed in the central repository that also includes the common (converged) taxonomy and linked sub-taxonomies. An inability to resolve all pre- and/or post-processing requirements results in a linkage failure condition resulting in either modifications to the optimized common taxonomy structure 710 or specific linkage modifications between CME platform services and resources, which can then be resolved in a subsequent link optimization processing activity.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as is suited to the particular use contemplated. All such modifications and variation are within the scope of this disclosure, as determined by the appended claims when interpreted in accordance with the breadth to which they are fairly and legally entitled.

At least the following is claimed:

1. A method that categorizes and maps telecommunication services comprising:
identifying entities of a communication, media, and entertainment (CME) environment, the CME environment including at least one service provider having multiple telecommunication platforms, the entities being associated with the multiple telecommunication platforms;
identifying entities in a shared information and data model (SID);
mapping the CME environment entities to the SID entities; and
developing a taxonomy for the CME environment.

2. The method as defined in claim 1, further comprising providing a common language among the providers and identifying the various entities in the providers, the entities being classified into a first level and a second level, the first level including the following entities: product, service, resource and party, the second level including the following entities: product offering, product specification, service specification, customer facing service (CFS), resource facing service (RFS), service characteristic, RFS atomic, RFS composite, logical resource (LR), physical resource (PR), and party role.

3. The method as defined in claim 1, further comprising defining common mappings for cross-domain product and services.

4. The method as defined in claim 3, further comprising mapping a converged product to sub-taxonomy structures.

5. The method as defined in claim 4, further comprising converging common taxonomy structures to facilitate developing the taxonomy for the CME environment, the common taxonomy structure being implemented at multiple service providers in the CME environment.

6. The method as defined in claim 5, further comprising linking common taxonomy products, services and resources with CME platforms.

7. The method as defined in claim 6, further comprising resolving non-transparent linkages and conflicts.

8. The method as defined in claim 7, further comprising loading the converged common taxonomy structures into central repository.

9. A system that categorizes and maps telecommunication services in a communication, media and entertainment (CME) environment, the system comprising:
at least one service provider that utilizes a computing device having:
a processing device that facilitates execution of programs stored in the computing device, and
memory that is electrically coupled to the processing device, the memory being configured to store the programs that include a taxonomy manager, the taxonomy manager being configured to:
identify entities of a communication, media and entertainment environment (CME), the CME environment including at least one service provider having multiple telecommunication platforms, the entities being associated with the multiple telecommunication platforms,
identify entities in a shared information and data model (SID),
map the CME environment entities to the SID entities, and
develop a taxonomy for the CME environment.

10. The system as defined in claim 9, wherein the taxonomy manager is configured to provide a common language among the providers and identify the various entities in the providers, the entities being classified into a first level and a second level, the first level including the following entities: product, service, resource and party, the second level including the following entities: product offering, product specification, service specification, customer facing service (CFS), resource facing service (RFS), service characteristic, RFS atomic, RFS composite, logical resource (LR), physical resource (PR), and party role.

11. The system as defined in claim 9, wherein the taxonomy manager is configured to define common mappings for cross-domain product and services.

12. The system as defined in claim 11, wherein the taxonomy manager is configured to map a converged product to sub-taxonomy structures.

13. The system as defined in claim 12, wherein the taxonomy manager is configured to converge common taxonomy structures to facilitate developing the taxonomy for the CME environment, the common taxonomy structure being implemented at multiple service providers in the CME environment.

14. The system as defined in claim 13, wherein the taxonomy manager is configured to link common taxonomy products, services and resources with CME platforms.

15. The system as defined in claim 14, wherein the taxonomy manager is configured to resolve non-transparent linkages and conflicts.

16. The system as defined in claim 15, wherein the taxonomy manager is configured to load the converged common taxonomy structures into central repository.

17. A computer having memory that includes a taxonomy manager, the taxonomy manager having a set of instructions, the instructions comprising:
logic to identify entities of a communication, media, and entertainment environment (CME), the CME environment including at least one service provider having multiple telecommunication platforms, the entities being associated with the multiple telecommunication platforms;
logic to identify entities in a shared information and data model (SID);
logic to map the CME environment entities to the SID entities; and
logic to develop a taxonomy for the CME environment.

18. The computer as defined in claim 17, wherein the taxonomy manager is configured to provide a common language among the providers and identify the various entities in the providers, the entities being classified into a first level and a second level, the first level including the following entities: product, service, resource and party, the second level including the following entities: product offering, product specification, service specification, customer facing service (CFS), resource facing service (RFS), service characteristic, RFS atomic, RFS composite, logical resource (LR), physical resource (PR), and party role.

19. The computer as defined in claim 17, wherein the taxonomy manager is configured to define common mappings for cross-domain product and services.

20. The computer as defined in claim 19, wherein the taxonomy manager is configured to map a converged product to sub-taxonomy structures.
